(19) United States
(12) Patent Application Publication
(10) Pub. No.: US 2022/0278513 A1
(43) Pub. Date: Sep. 1, 2022

(54) 360 DEGREE COUPLING

(71) Applicant: Timothy James, Lumberton, TX (US)

(72) Inventor: Timothy James, Lumberton, TX (US)

(21) Appl. No.: 17/187,739

(22) Filed: Feb. 27, 2021

(51) Int. Cl. H02G 3/06; F16L 21/03

(52) U.S. Cl. CPC H02G 3/06; F16L 21/03

(57) ABSTRACT

An illustrated view of an exemplary 360-degree coupling for ease of repair and maintenance for an electrical pipe is presented. The 360-degree coupling is useful for providing a means to separate cemented electrical piping eliminating breakage of the piping. The 360-degree coupling can be used by anyone, professional or do-it-yourselfer. The 360-degree coupling is cost efficient and material efficient.

### FIELD OF THE INVENTION

This invention relates to electrical pipes. More particularly, it relates to a movable coupling for electrical pipes.

### BACKGROUND

An electrical conduit is a tube used to protect and route electrical wiring in a building or structure. Electrical conduit may be made of metal, plastic, fiber, or fired day. Most conduit is rigid, but flexible conduit is used for some purposes.

Conduit is generally installed by electricians at the site of installation of electrical equipment. Its use, form, and installation details are often specified by wiring regulations, such as the US National Electrical Code (NEC) and other building codes.

Conduit may be installed underground between buildings, structures, or devices to allow installation of power and communication cables. An assembly of these conduits, often called a duct bank, may either be directly buried in earth, or encased hi concrete (sometimes with reinforcing rebar to aid against shear forces) Alternatively, a duct bank may be installed in a utility tunnel. A duct bank will allow replacement of damaged cables between buildings or additional power and communications circuits to be added, without the expense of re-excavation of a trench. While metal conduit is occasionally used for burial, usually PVC, polyethylene or polystyrene plastics are now used due to lower cost, easier installation, and better resistance to corrosion.

Formerly, compressed asbestos fiber mixed with cement such as transite) was used for some underground installations. Telephone and communications circuits were typically installed in fired-clay conduit.

Couplings connect two pieces of conduit together.

Sometimes the fittings are considered sufficiently conductive to bond (electrically unite) the metal conduit to a metal junction box (thus sharing the box's ground connection); other times, grounding bushings are used which have bonding jumpers from the bushing to a grounding screw on the box.

Unlike water piping, if the conduit is to be watertight, the idea is to keep water out, not in. In this case, gaskets are used with special fittings, such as the weather-head leading from the overhead electrical mains to the electric meter.

Flexible metal conduit usually uses fittings with a clamp on the outside of the box, just like bare cables would.

In the process of laying electrical conduit, in the ground or above, there typically is a point that joints must be made or a “swing 90” must be glued to the pipe. If the swing 90 is glued incorrectly, it must be cut off and the process starts over. This can cause additional time, effort and cost, as well as additional piping to repair, replace or lay the pipe.

According, and in light of the foregoing, there is a need for a device that will overcome any incorrectly glued pipe that may have occurred during previous piping.

### BRIEF DESCRIPTION OF THE DRAWINGS

FIGS. 1A and 1B are illustrated views of an exemplary 360-degree coupling.

FIGS. 2A, 2B and 2C are illustrated exemplary assembly of the exemplary 360-degree coupling shown in FIG. 1B.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

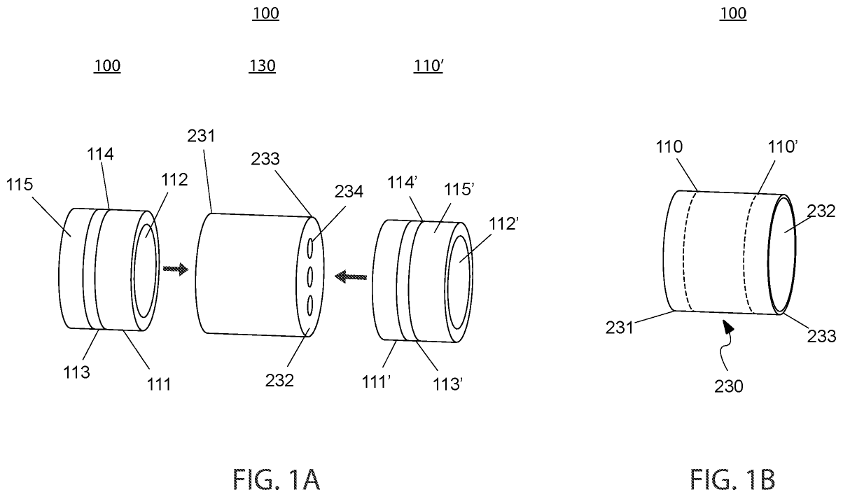

Referring to FIGS. 1A and 1B, illustrated views of an exemplary 360-degree coupling 100 for ease of repair and maintenance for an electrical pipe is presented. The 360-degree coupling 100 is useful for providing a means to separate cemented electrical piping eliminating breakage of the piping and to allow a twisting of the pipe for fitting the pipe to a desired location. The 360-degree coupling 100 can be used by anyone, professional or do-it-yourselfer. The 360-degree coupling 100 is cost efficient and material efficient.

The 360-degree coupling 100 is preferably made of a poly-vinyl chloride (PVC) material, however, other materials are hereby contemplated, including, but not limited to, vinyl, metal, high-density poly-ethylene (HDPE), etc. The 360-degree coupling 100 is movable. The 360-degree coupling 100 is preferably a diameter of between three-fourth and three (0.75-3) inches, however, other diameters are hereby contemplated, including, but not limited to, one-half (0.5) inch, three and one-half (3.5) inches, etc. The 360-degree coupling 100 is preferably round in shape.

The 360-degree coupling 100 has a plurality of rings 110, 110′ and a coupling portion 230. Each of the rings 110, 110′ have an outside 111, 111′, an interior 112, 112′ and an O-ring 113, 113′. The interior 112, 112′ of the rings 110, 110′ have one or more ridges (not shown), however the interior of the rings 110, 110′ may be smooth.

The O-ring 113, 113′ is useful for allowing a stronger 360-degree coupling 100 when coupled to the electrical pipe. The O-ring 113, 113′ is removably coupled to a groove 115, 115′ of a center portion 114, 114′ of the outside 111, 111′ of the rings 110, 110′. The O-ring 113, 113′ is preferably made of a rebar material; however, the O-ring 113, 113′ may be made of any type of material such as silicone.

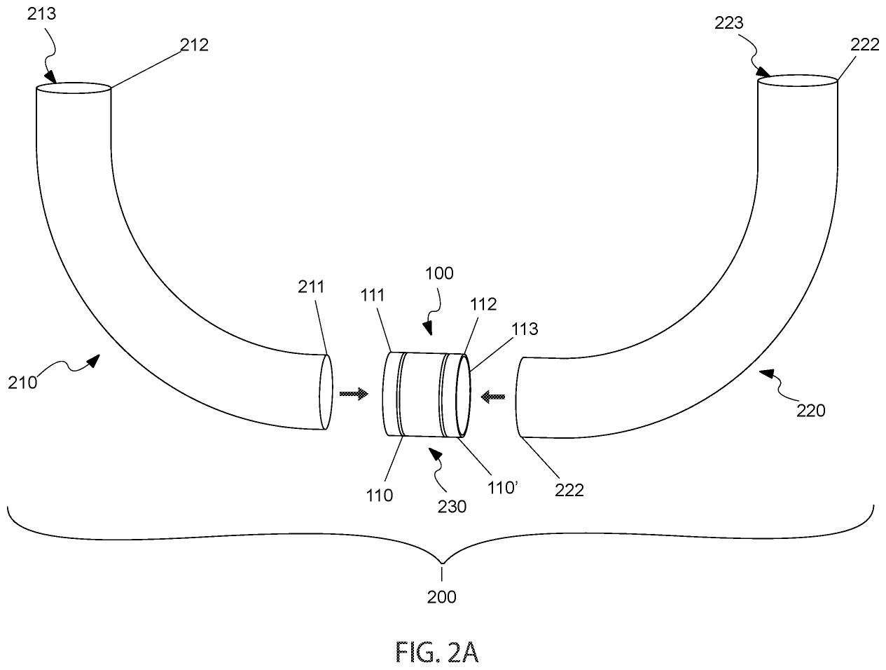

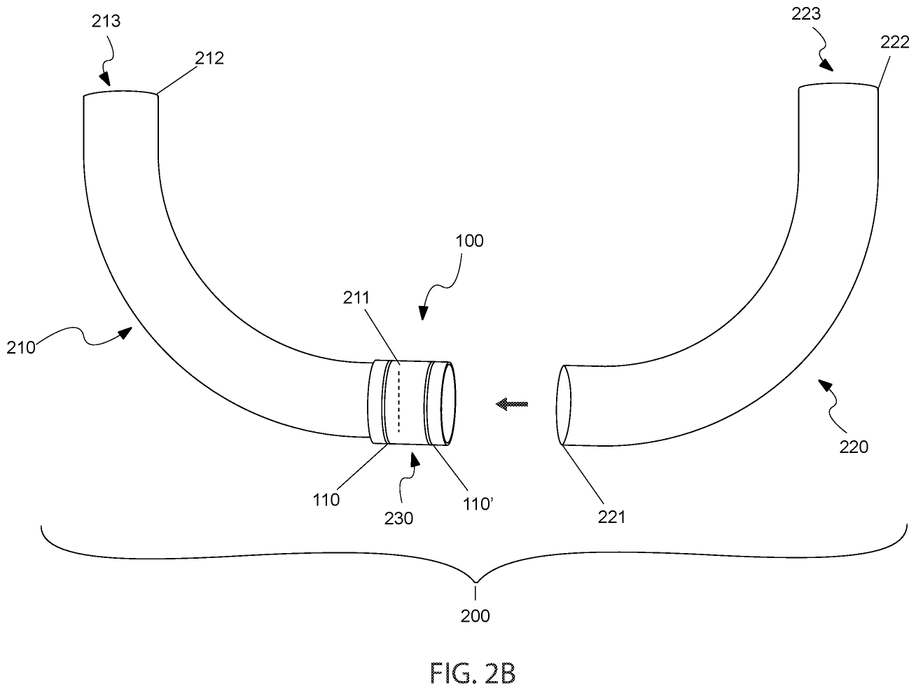

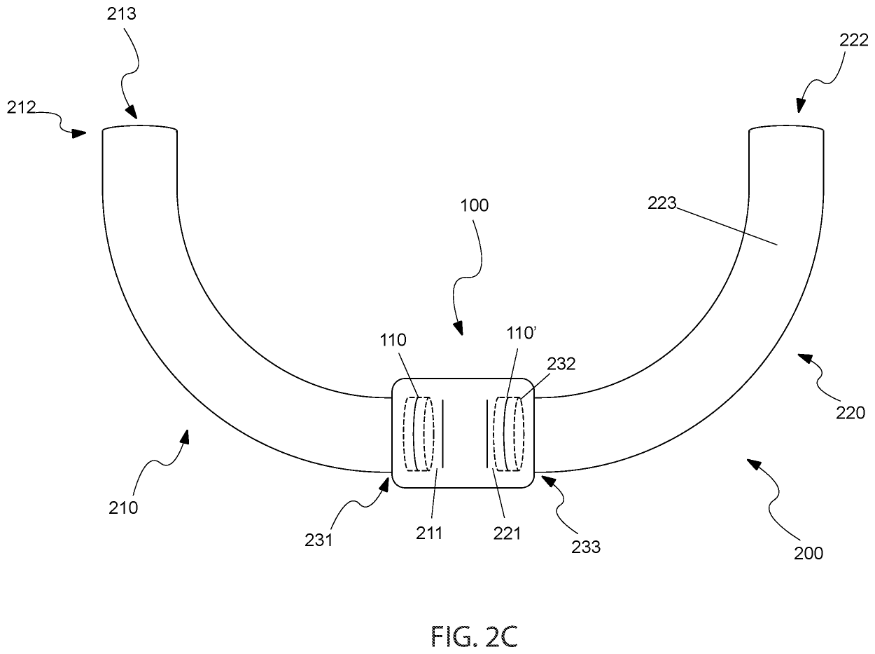

The coupling portion 230 is useful for providing a secure connection when coupled to a pipe 200 (shown in FIGS. 2A, 2B and 2C). The coupling portion 230 is preferably made of a poly-vinyl chloride (PVC) material. The coupling portion 230 further has a plurality of knobs 234 on an inside 232 of the coupling portion 230. The knobs 234 are configured to securely couple the coupling portion 230 to each of the rings 110, 110′ and further for allowing a turning of the pipe 200 (see FIGS. 2A, 2B, 2C).

In FIG. 1B, the first of the rings 110 is coupled to an inside 232 of a first end 231 of the coupling portion 230 where the O-ring 113 is in the inside 231 of the coupling portion 230.

The second of the rings 110′ is coupled to the inside 232 of a second end 233 of the coupling portion 230 where the O-ring 113′ is in the inside 231 of the coupling portion 230.

Moving now to FIGS. 2A, 2B and 2C, illustrated views of exemplary use of the exemplary 360-degree coupling 100 shown in FIG. 1B is presented.

A pipe 200 has a first portion 210 and a second portion 220. The first portion 210 of the pipe 200 has a first end 211, a second end 212 and an interior 213. The interior 213 is preferably open between the first end 211 of the first portion 210 and the second end 212 of the first portion 211.

The second portion 2120 of the pipe 200 has a first end 221, a second end 222 and an interior 223. The interior 223 is preferably open between the first end 221 of the second portion 220 of the pipe 200 and the second end 222 of the first portion 221 of the pipe 200.

The coupling portion 230 is completed, as shown in FIG. 1B, where the first of the rings 110 and the second of the rings 110′ are securely and removably coupled to the inside of the coupling portion 230

In FIG. 2B, the coupling portion 230 is securely coupled to the first end 211 of the first portion 210. The first end 211 is inserted into and coupled to the first end 231 of the coupling portion 230, where the first end 211 of the first portion 210 of the pipe 200 is fully engaged to the interior 112 of the first of the rings 110.

In FIG. 2C, the coupling portion 230 is securely coupled to the first end 211 of the first portion 210 as shown in FIG. 2B.

The coupling portion 230 is then securely coupled to the first end 221 of the second portion 210. The first end 221 of the second portion 210 is inserted into and coupled to the second end 233 of the coupling portion 230, where the first end 221 of the second portion 220 of the pipe 200 is fully engaged to the interior 112′ of the second of the rings 110′.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A 360-degree coupling device for ease of repair and maintenance for an electrical pipe, the device comprising:
a plurality of rings, each of the rings comprising:
an outside;
an interior, wherein the interior being open;
a groove, the grove configured to be in a middle portion of the outside of the device, the grove being for receiving an O-ring; and
a coupling device, wherein a first of the rings being coupled to an inside of a first end of the coupling device, and wherein a second of the rings being coupled to the inside of a second end of the coupling device.

2. The device of claim 1, wherein the O-ring being made of a rebar material.

3. The device of claim 1, wherein the device having a diameter being between three-fourths and three (0.75-3) inches.

4. The device of claim 1, wherein the device being made of a poly-vinyl chloride (PVC) material.

5. The device of claim 1, wherein the interior having a smooth finish.

6. The device of claim 1, wherein the device being for coupling a first portion of an pipe to a second portion of the pipe.

7. The device of claim 1, wherein the device being a round shape.

8. The device of claim 1, wherein the device being movable.
